(19) United States
(12) Patent Application Publication
(10) Pub. No.: US 2016/0294061 A1
(43) Pub. Date: Oct. 6, 2016

(54) Integrated Antenna Structure

(71) Applicant: Microsoft Technology Licensing, LLC, Redmond, WA (US)

(72) Inventor: Marc Harper, Seattle, WA (US)

(21) Appl. No.: 14/673,314

(22) Filed: Mar. 30, 2015

(51) Int. Cl. H01Q 9/04; H01Q 1/38

(52) U.S. Cl. CPC H01Q 9/0414; H01Q 1/38

(57) ABSTRACT

Techniques for implementing an integrated antenna structure are described. In at least some implementations, the integrated antenna structure includes an antenna that is folded and/or meandered in design to enable the antenna to be incorporated into a compact area. The integrated antenna structure further includes the antenna electrically attached to a chassis of a device. According to various implementations, the antenna and the chassis combine to form an integrated radiating structure that enables the device to send and/or receive wireless signals.

### BACKGROUND

Many devices today utilize some form of wireless technology to transmit and receive information. Such devices typically include an antenna that enables wireless signals to be transmitted and received. Designing a suitable antenna for a device can present a number of challenges. For example, the size of an antenna can affect the overall form factor of a device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for implementing an integrated antenna structure are described. In at least some implementations, the integrated antenna structure includes an antenna that is folded and/or meandered in design to enable the antenna to be incorporated into a compact area. The integrated antenna structure further includes the antenna electrically attached to a chassis of a device. According to various implementations, the antenna and the chassis combine to form an integrated radiating structure that enables the device to send and/or receive wireless signals.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 depicts an example implementation of a client device with an integrated antenna structure in accordance with one or more implementations.

FIG. 3 depicts an example antenna in accordance with one or more embodiments.

FIG. 4 depicts internal components of an example client device including an example integrated antenna structure in accordance with one or more embodiments.

FIG. 5 depicts internal components of an example client device including an example integrated antenna structure in accordance with one or more embodiments.

FIG. 6 depicts internal components of an example client device including an example integrated antenna structure in accordance with one or more embodiments.

FIG. 7 illustrates various matching characteristics of a typical antenna that does not utilize the integrated antenna structure described herein.

FIG. 8 illustrates various matching characteristics of an example antenna that utilizes the integrated antenna structure described herein

FIG. 9 illustrates various components of an example device that can be implemented as any type of portable and/or computer device as described with reference to FIG. 1 to implement embodiments of the techniques described herein.

### DETAILED DESCRIPTION

Overview

Techniques for implementing an integrated antenna structure are described. In at least some implementations, the integrated antenna structure includes an antenna that is folded and/or meandered in design to enable the antenna to be incorporated into a compact area. The integrated antenna structure further includes the antenna electrically attached to a chassis of a device. According to various implementations, the antenna and the chassis combine to form an integrated radiating structure that enables the device to send and/or receive wireless signals. The integrated antenna structure may be used to transmit and receive signals according to a variety of standardized or proprietary protocols, including, for example, Long-Term Evolution (LTE) cellular communications.

In the following discussion, an example environment is first described that is operable to employ techniques for implementing integrated antenna structures described herein. Next, a section entitled “Integrated Antenna Structure” describes some example aspects of integrated antenna structures in accordance with one or more embodiments. Finally, an example system and device are described that are operable to employ techniques discussed herein in accordance with one or more embodiments.

Example Environment

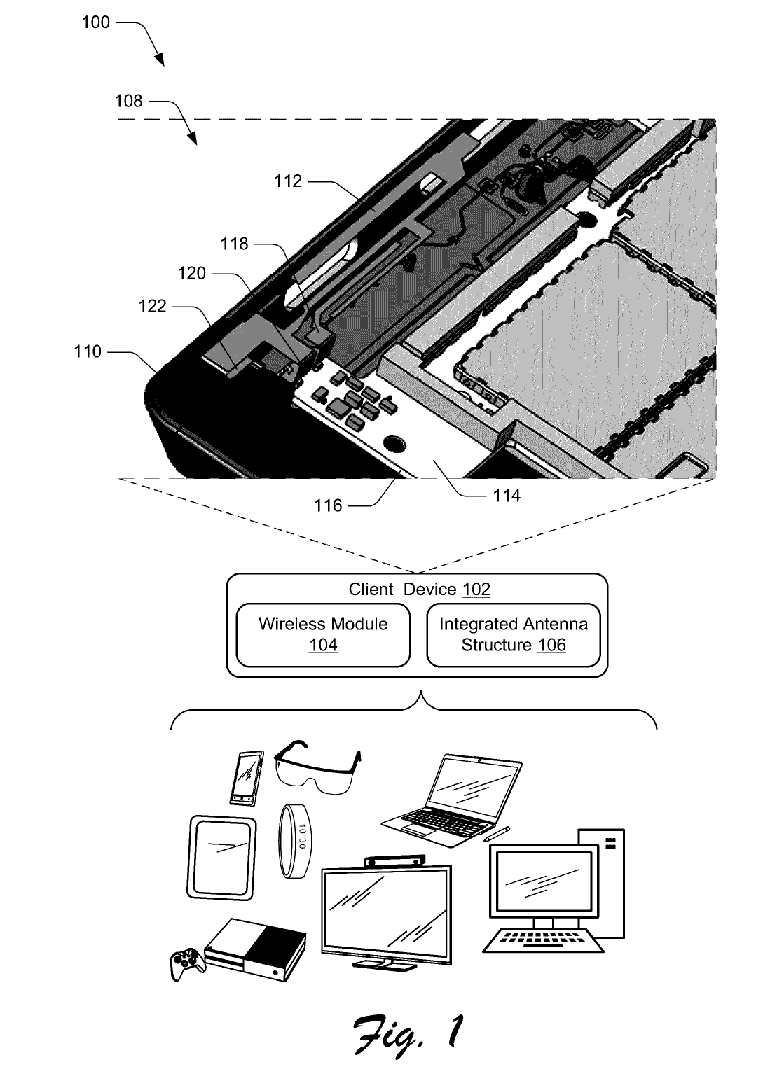

FIG. 1 is an illustration of an environment 100 in an example implementation that is operable to employ techniques for implementing an integrated antenna structure. Environment 100 includes a client device 102 having a wireless module 104 and an integrated antenna structure 106. The wireless module 104 is representative of functionality to enable the device 102 to communicate using various wireless techniques and/or protocols. Examples of such techniques and/or protocols include wireless cellular communications, the 802.11 protocols, Bluetooth, radio communications, and so on.

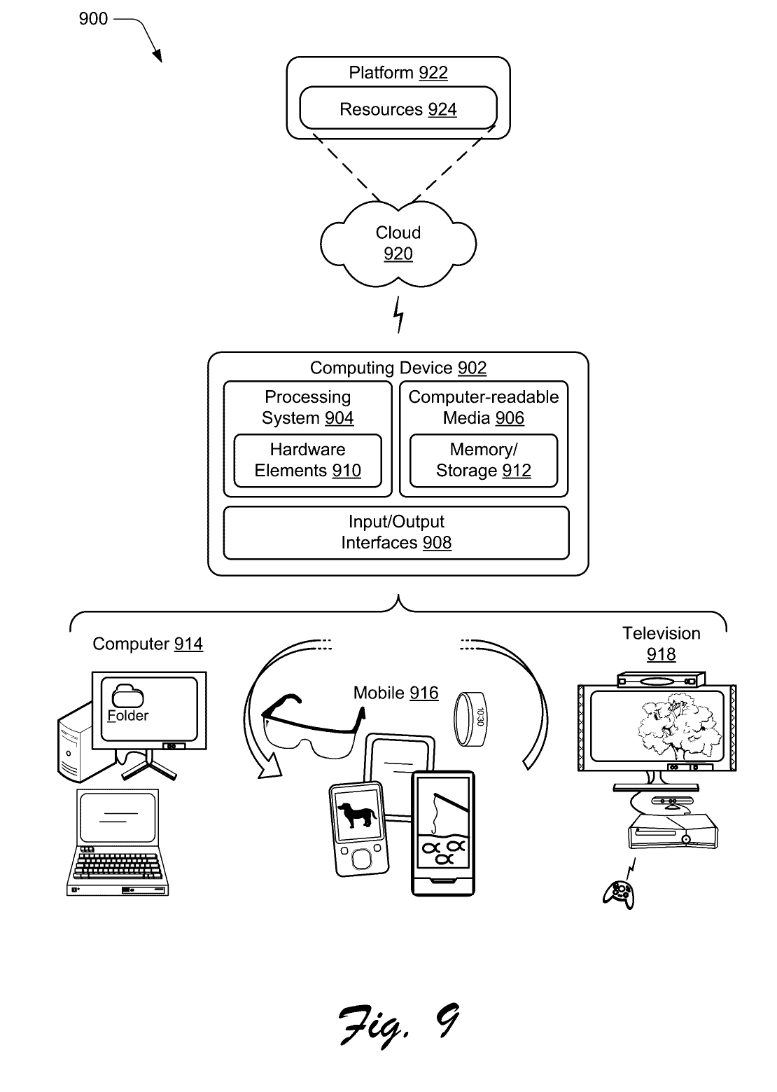

The client device 102 can be embodied as any suitable device such as, by way of example and not limitation, a smartphone, a tablet computer, a portable computer (e.g., a laptop), a desktop computer, a wearable device, and so forth. In at least some implementations, the client device 102 represents a smart appliance, such as an Internet of Things (“IoT”) device. Thus, the client device 102 may range from a system with significant processing power, to a lightweight device with minimal processing power. One of a variety of different examples of a client device 102 is shown and described below in FIG. 9.

The environment 100 further includes a partial view 108 of the client device 102. The partial view 108 illustrates a corner portion of a chassis 110 of the client device 102 with an outer covering of the client device 102 removed to reveal various internal components of the client device 102. The chassis 110 generally represents a portion of the client device 102 in which/on which various components of the client device 102 are positioned, and is formed from a metallic and/or electrically-conductive material. Positioned within the chassis 110 is an antenna 112. According to various implementations, the antenna 112 is formed out of metallic and/or electrically conductive material that can transmit and/or receive wireless signals. For example, the antenna can be formed as a wire trace design that can conform to various configurations discussed herein. Further examples and implementations of the antenna 112 are discussed in more detail below.

The antenna 112 is electrically attached to a printed circuit board (PCB) 114, which is representative of a structure that is used to mechanically support and electrically connect electronic components of the client device 102. For example, the PCB 114 can connect various components of the device 102 using conductive pathways, tracks, signal traces, and so on, etched from sheets of electrically conductive material (e.g., copper) laminated onto a non-conductive substrate. Included as part of the PCB 114 is a ground plane 116, which is representative of a surface and/or layer of the PCB 114 that is formed from electrically conductive material. In implementations, the ground plane 116 provides an electrical ground connection for various components of the device 102 that connect to the ground plane.

The antenna 112 connects to the PCB 116 via a feed connection 118 and a ground plane connection 120. The feed connection 118 represents a connection of the antenna 112 to internal components of the client device 102, such as a wireless radio, a modem, the wireless module 104, and so forth. The ground plane connection 120 represents a ground connection to the ground plane 116. Generally, the ground plane 116 represents a grounding surface separate from other portions of the client device 102, e.g., separate from the chassis 110.

The antenna 112 is also electrically connected to the chassis 110 via a chassis ground connection 122. As referenced above, the chassis 110 is formed from a metallic and/or electrically conductive material. Thus, and as further detailed below, connection of the antenna 112 to the chassis 110 creates an integrated antenna structure for transmitting and receiving wireless signal for the client device 102. For instance, connection of the antenna 112 to the chassis 110 increases an electrical footprint of the antenna 112 as compared to implementing the antenna 112 without a connection to the chassis 110.

Connection of the chassis ground connection 122 to the chassis 110 may be performed in various ways. For instance, the chassis ground connection 122 can be pressed into a recess formed in the chassis 110. In at least some implementations, an electrically conductive foam may be utilized between the chassis ground connection 122 and the chassis 110 to enable electrical conductivity between the two.

Having described an example environment, consider now a discussion of some example features of an integrated antenna structure in accordance with one or more embodiments.

Integrated Antenna Structure

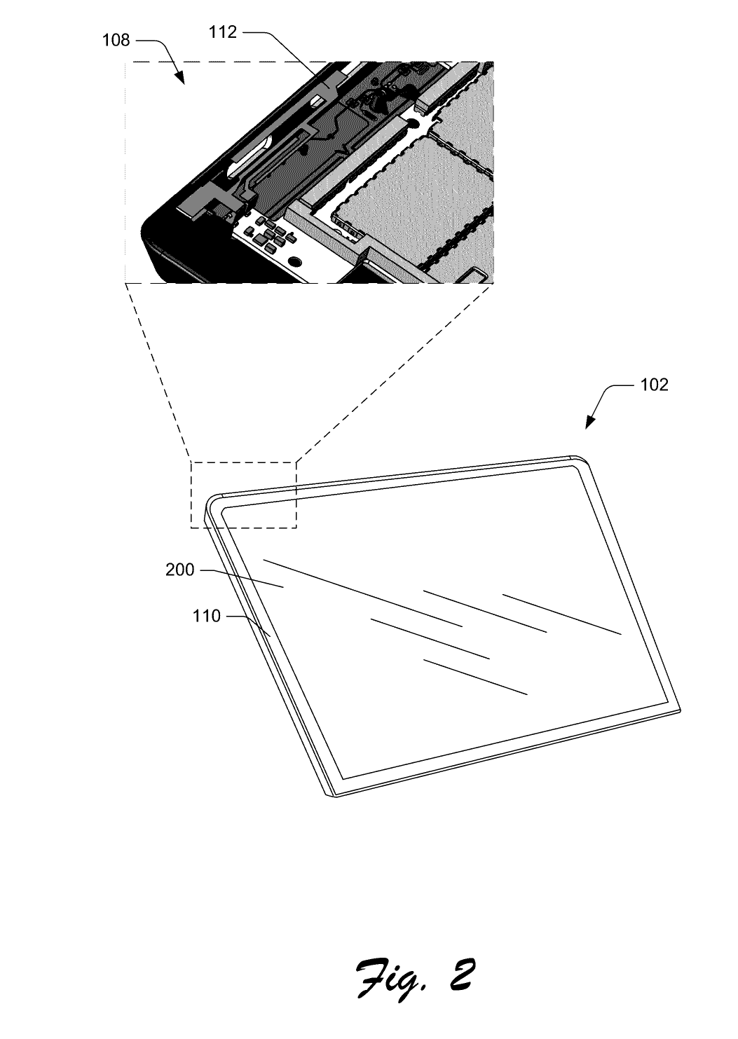

FIG. 2 depicts an example implementation of the client device 102, which in this particular example represents a portable computing device such as a tablet. The client device 102 includes a display surface 200 mounted within the chassis 110 and which is representative of a visual output surface of the client device 102. The partial view 108 is further depicted as representing a portion of the client device 102. For instance, the partial view 108 depicts internal portions of the client device 102 with the display surface 200 removed. Thus, in at least some implementations, the antenna 112 and various other internal components of the client device 102 discussed herein are positioned at least partially beneath the display surface 200.

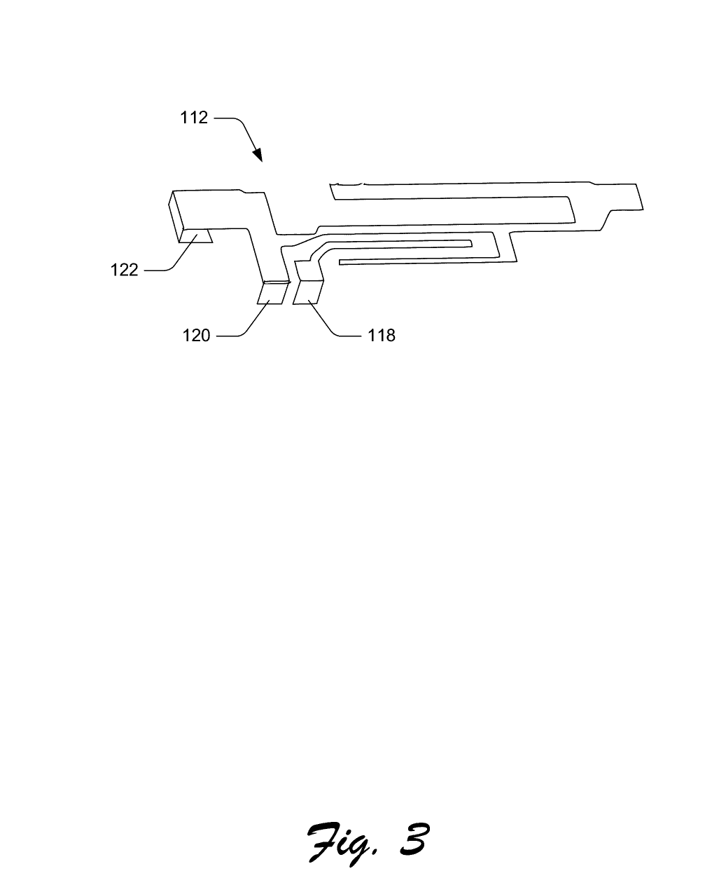

FIG. 3 depicts the antenna 112 separately from other portions of the client device 102. The antenna 112 further includes the feed connection 118, the ground plane connection 120, and the chassis ground connection 122.

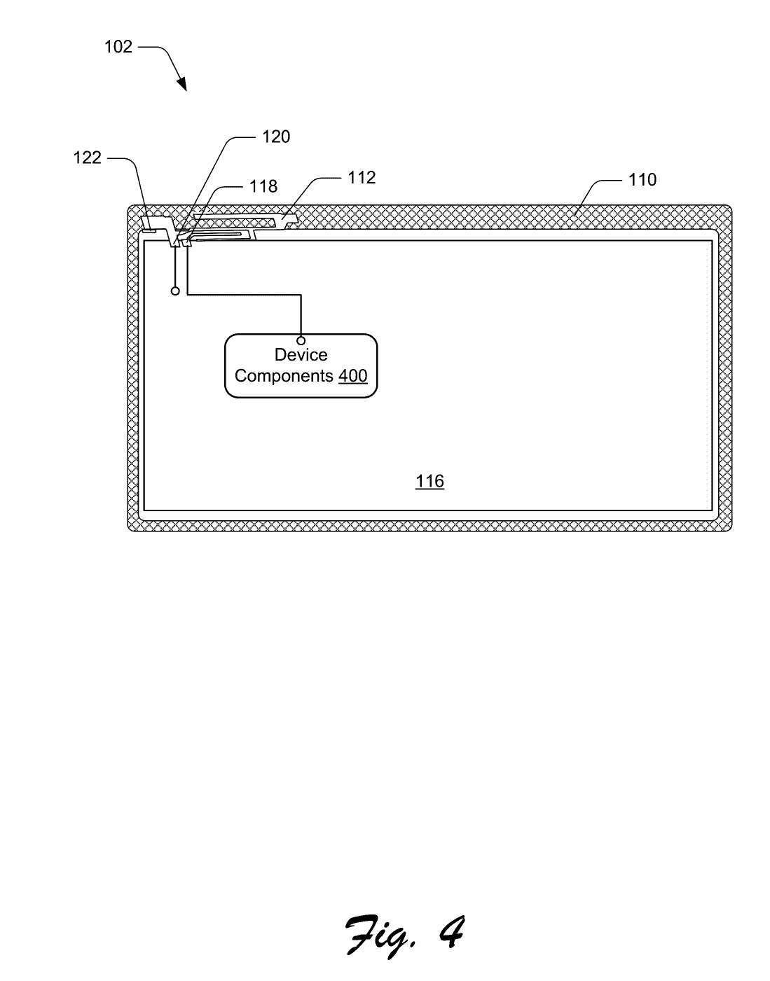

FIG. 4 depicts the client device 102 with an outer surface (e.g., the display surface 200) removed such that various internal components of the client device 102 are visible. For instance, FIG. 3 depicts the antenna 112 electrically connected from the feed connection 118 to device components 300. The device components 300 are representative of components that enable the client device 102 to communicate via wireless signals, e.g., to transmit and receive wireless signals. Examples of the internal components include electronic circuits (e.g., wireless circuits), a wireless radio, a modem, impedance matching functionality, and so forth. The device components 400, for example, represent one or more components connected (e.g. soldered) to the PCB 114.

Further depicted is the ground plane connection 120 electrically connected to the ground plane 116, and the chassis ground connection 122 electrically connected to the chassis 110. Connection of the antenna 112 to the chassis 110 causes the antenna 112 and the chassis 110 to act as an integrated antenna structure such that the antenna 112 and the chassis 110 cooperate to receive and transmit wireless signal. For instance, the antenna 112 and the chassis 110 form an integrated radiating structure for transmitting and receiving wireless signal.

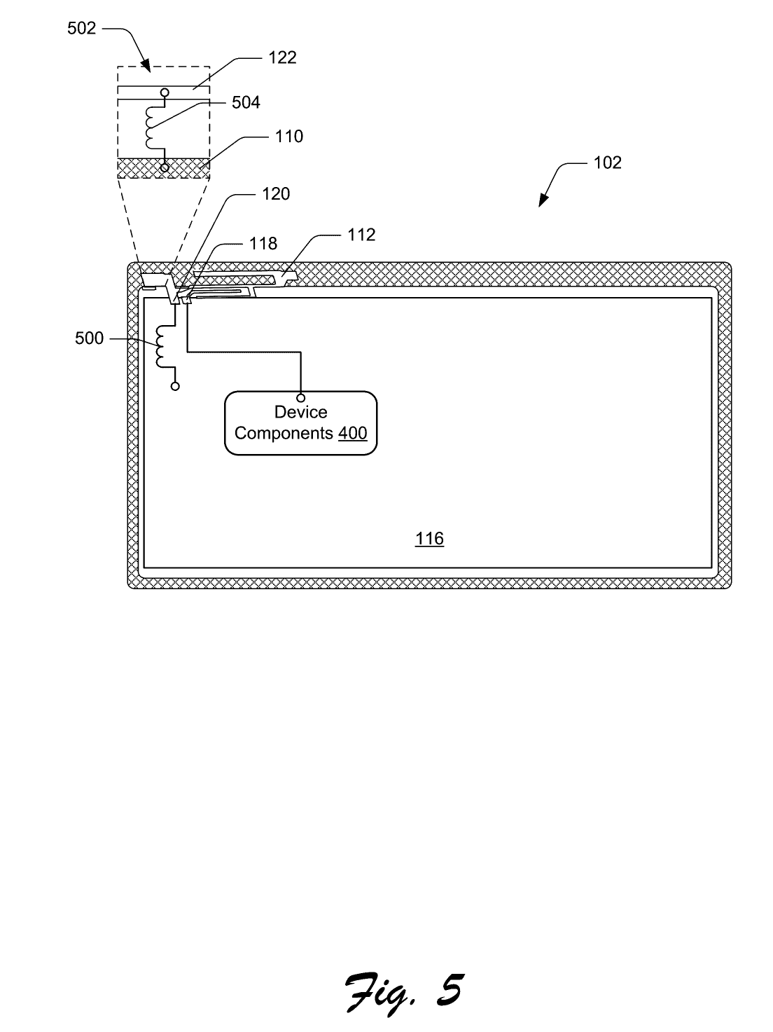

FIG. 5 depicts the client device 102 with an outer surface (e.g., the display surface 200) removed such that various internal components of the client device 102 are visible. FIG. 5, for instance, represents a variation and/or extension of the implementation discussed above with reference to FIG. 4. FIG. 5 depicts the antenna 112 electrically connected from the feed connection 118 and to the device components 400.

FIG. 5 further depicts an inductor 500 connected between the ground plane connection 120 and the ground plane 116. According to various implementations, inserting the inductor 500 into the connection between the ground plane connection 120 and the ground plane 116 enables customization of properties of the antenna 112, such as by changing (e.g., increasing) the inductance of the antenna 112 and thus the integrated antenna structure formed via the combination of the antenna 112 and the chassis 110. Altering the inductance of the integrated antenna structure enables optimization and/or customization of the bandwidth and/or impedance of the integrated antenna structure.

FIG. 5 further depicts a partial cross section 502 of a portion of the client device 102, showing an inductor 504 connected between the chassis ground connection 122 and the chassis 110. According to various implementations, inserting the inductor 504 into the connection between the chassis ground connection 122 and the chassis 110 enables customization of properties of the antenna 112, such as by changing (e.g., increasing) the inductance of the antenna 112 and thus the integrated antenna structure formed via the combination of the antenna 112 and the chassis 110. Altering the inductance of the integrated antenna structure enables optimization of the bandwidth and/or impedance of the integrated antenna structure.

According to various implementations, the inductors 500, 502 may be utilized together in a particular implementation, or alternatively in alternative implementations.

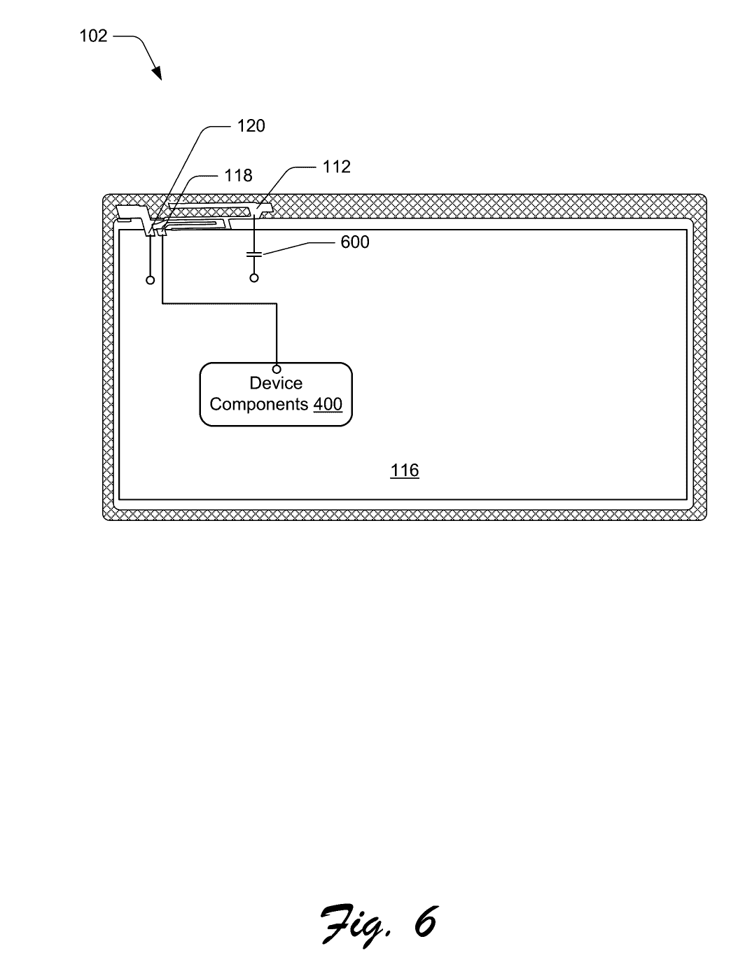

FIG. 6 depicts the client device 102 with an outer surface (e.g., the display surface 200) removed such that various internal components of the client device 102 are visible. FIG. 6, for instance, represents a variation and/or extension of one or more of the implementations discussed above with reference to FIGS. 3-5. FIG. 6 depicts the antenna 112 electrically connected from the feed connection 118 to device components 400, and from the ground plane connection 120 to the ground plane 116.

FIG. 6 further depicts a capacitor 600 connected in line between the antenna 112 and the ground plane 116. According to various implementations, connecting the capacitor 600 between the antenna 112 and the ground plane 116 alters the capacitance of the antenna 112 and thus the frequency response of the integrated antenna structure formed by the antenna 112 and the chassis 110. For instance, the capacitor 600 is selected to customize the frequency at which the antenna 112 resonates by altering the capacitance value to the ground plane 116. For example, connecting the capacitor 600 between the antenna 112 and the ground plane 116 loads the antenna with capacitance to tune the antenna 112, such as to customize a frequency response of the integrated antenna structure formed via interaction between the antenna 112 and the chassis 110.

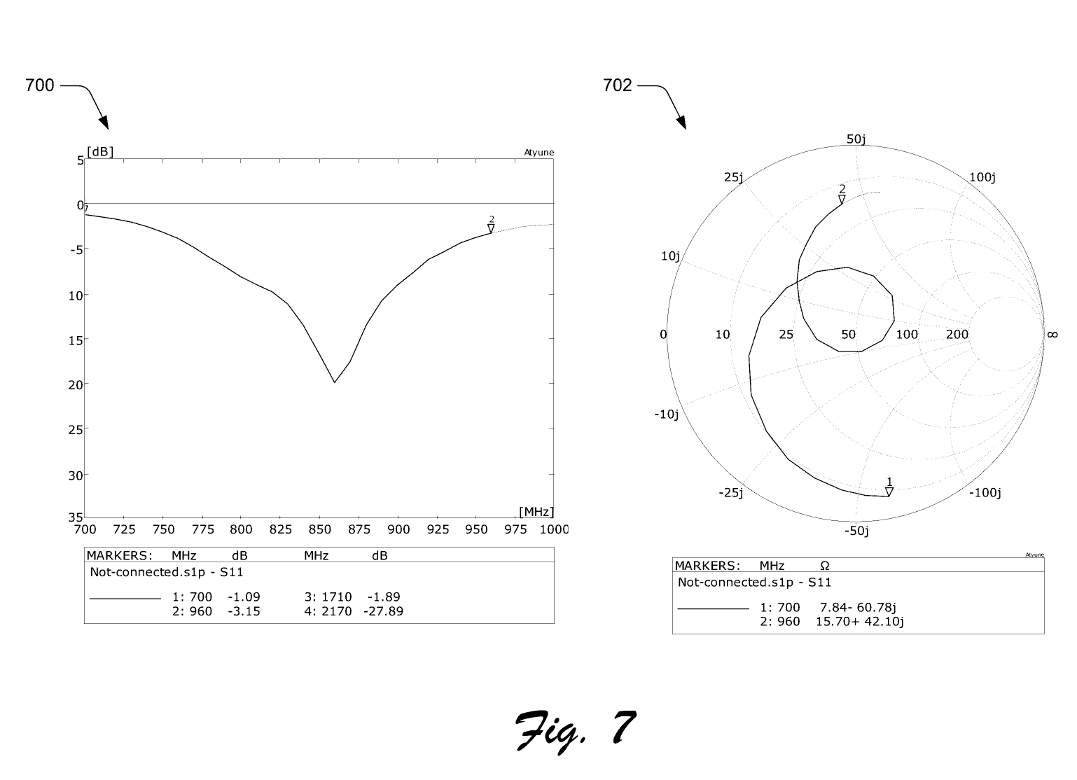

FIG. 7 illustrates various matching characteristics of a typical antenna that does not utilize the integrated antenna structure described herein. Generally, a desirable return loss for an antenna in frequencies of interest will be less than −6 decibels (dB). As illustrated in a chart 700, an antenna that does not utilize the integrated antenna structure discussed herein exhibits a very narrow frequency range below the desirable return loss of −6 dB.

Further illustrated is a Smith chart 702, which represents different impedance values for an antenna that does not utilize the integrated antenna structure discussed herein. As illustrated, this particular antenna varies significantly from the desired (e.g., normalized) impedance of 50 ohms.

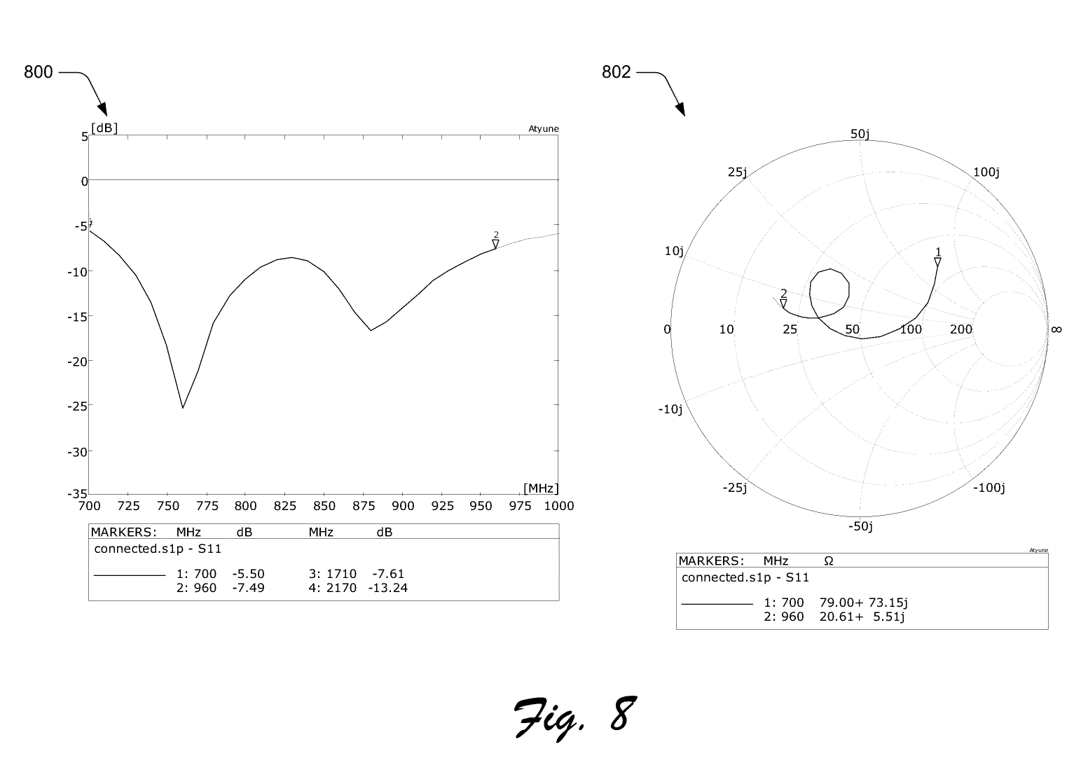

FIG. 8 illustrates various matching characteristics of an example antenna that utilizes the integrated antenna structure described herein. The matching characteristics indicated in FIG. 8, for instance, represent characteristics of the integrated antenna structure described above with reference to FIGS. 1-6.

As illustrated in a chart 800, the integrated antenna structure exhibits a significantly increased frequency range below the desirable return loss of −6 dB as compared to the antenna characterized above with reference to FIG. 7. Further, a Smith chart 802 shows a significantly optimized impedance for the integrated antenna structure in the region of 50 ohms.

While FIGS. 7 and 8 illustrate frequency responses in a particular set of frequency ranges, it is to be appreciated that implementations for an integrated antenna structure discussed herein can be implemented according to a variety of different configurations and/or dimensions in order to provide functionality in a variety of different wireless signal frequency ranges. It is to be further appreciated that such variations are considered to be within the spirit and scope of the embodiments claimed herein.

Having described attributes of an example integrated antenna structure, consider now a discussion of an example system and device in accordance with one or more embodiments.

Example System and Device

FIG. 9 illustrates an example system generally at 900 that includes an example computing device 902 that is representative of one or more computing systems and/or devices that may implement various techniques described herein. For example, the client device 102 discussed above with reference to FIG. 1 can be embodied as the computing device 902. The computing device 902 may be, for example, a server of a service provider, a device associated with the client (e.g., a client device), an on-chip system, and/or any other suitable computing device or computing system.

The example computing device 902 as illustrated includes a processing system 904, one or more computer-readable media 906, and one or more Input/Output (I/O) Interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 910 and computer-readable media 906 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of modules that are executable by the computing device 902 as software may be achieved at least partially in hardware, e.g., through use of computer-readable storage media and/or hardware elements 910 of the processing system. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 902 may assume a variety of different configurations, such as for computer 914, mobile 916, and television 918 uses. Each of these configurations includes devices that may have generally different constructs and capabilities, and thus the computing device 902 may be configured according to one or more of the different device classes. For instance, the computing device 902 may be implemented as the computer 914 class of a device that includes a personal computer, desktop computer, a multi-screen computer, laptop computer, netbook, and so on.

The computing device 902 may also be implemented as the mobile 916 class of device that includes mobile devices, such as a mobile phone, portable music player, portable gaming device, a tablet computer, a wearable device, a multi-screen computer, and so on. The computing device 902 may also be implemented as the television 918 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. For example, functionalities discussed with reference to the client device 102 may be implemented all or in part through use of a distributed system, such as over a “cloud” 920 via a platform 922 as described below.

The cloud 920 includes and/or is representative of a platform 922 for resources 924. The platform 922 abstracts underlying functionality of hardware (e.g., servers) and software resources of the cloud 920. The resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices. The platform 922 may also serve to abstract scaling of resources to provide a corresponding level of scale to encountered demand for the resources 924 that are implemented via the platform 922. Accordingly, in an interconnected device embodiment, implementation of functionality described herein may be distributed throughout the system 900. For example, the functionality may be implemented in part on the computing device 902 as well as via the platform 922 that abstracts the functionality of the cloud 920.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include:

### Example 1

A wireless device comprising: a chassis; one or more electronic circuits positioned within the chassis; a ground plane positioned within the chassis; and an antenna electrically attached to the one or more electronic circuits, the ground plane, and the chassis to form an integrated antenna structure configured to transmit and receive wireless signals for the wireless device.

### Example 2

A wireless device as described in example 1, wherein the antenna and the chassis combine to form an integrated radiating structure configured to transmit and receive the wireless signals by performing one or more of transmitting radio waves or receiving radio waves.

### Example 3

A wireless device as described in one or more of examples 1 or 2, wherein the antenna is electrically attached to the chassis, the one or more electronic circuits, and the ground plane via separate respective connections.

### Example 4

A wireless device as described in one or more of examples 1-3, further comprising an inductor connected between the antenna and the ground plane to customize an inductance of the integrated antenna structure.

### Example 5

A wireless device as described in one or more of examples 1-4, further comprising an inductor connected between the antenna and the chassis to customize an inductance of the integrated antenna structure.

### Example 6

A wireless device as described in one or more of examples 1-5, further comprising a capacitor connected between the antenna and the ground plane to customize a capacitance of the integrated antenna structure.

### Example 7

A wireless device as described in one or more of examples 1-6, wherein the electronic circuits comprise a wireless module configured to interact with the antenna to enable wireless signal to be transmitted and received by the client device.

### Example 8

An integrated antenna structure comprising: a chassis; and an antenna electrically attached to the device chassis such that the antenna and the chassis combine to form an integrated radiating structure configured to transmit and receive wireless signals for a wireless device.

### Example 9

An integrated antenna structure as described in example 8, further comprising a ground plane separate from the chassis and to which the antenna is electrically attached separately from the chassis.

### Example 10

An integrated antenna structure as described in one or more of examples 8 or 9, further comprising one or more electronic circuits to which the antenna is electrically attached separately from the chassis.

### Example 11

An integrated antenna structure as described in one or more of examples 8-10, further comprising: a ground plane separate from the chassis and to which the antenna is electrically attached separately from the chassis; and one or more electronic circuits to which the antenna is electrically attached separately from the chassis and the ground plane.

### Example 12

An integrated antenna structure as described in one or more of examples 8-11, further comprising a ground plane separate from the chassis and to which the antenna is electrically attached separately from the chassis, and an inductor connected between the antenna and the ground plane to customize an inductance of the integrated antenna structure.

### Example 13

An integrated antenna structure as described in one or more of examples 8-12, further comprising an inductor connected between the antenna and the chassis to customize an inductance of the integrated antenna structure.

### Example 14

An integrated antenna structure as described in one or more of examples 8-13, further comprising an electrically conductive foam positioned between the antenna and the chassis that enables electrical attachment of the antenna to the chassis.

### Example 15

A computing device comprising: a chassis; a display surface mounted on an outer portion of the chassis; and an antenna positioned within the chassis at least partially beneath the display surface and electrically attached to the chassis such that the antenna and the chassis combine to form an integrated radiating structure configured to transmit and receive wireless signals for the computing device.

### Example 16

A computing device as described in example 15, further comprising a ground plane positioned within the chassis at least partially beneath the display surface and to which the antenna is electrically attached separately from the chassis.

### Example 17

A computing device as described in one or more of examples 15 or 16, further comprising one or more electronic circuits positioned within the chassis at least partially beneath the display surface and to which the antenna is electrically attached separately from the chassis.

### Example 18

A computing device as described in one or more of examples 15-17, further comprising: a ground plane positioned within the chassis at least partially beneath the display surface; and one or more electronic circuits positioned within the chassis at least partially beneath the display surface, the antenna connected to the chassis, the ground plane, and the one or more electronic circuits via different respective electrical connections.

### Example 19

A computing device as described in one or more of examples 15-18, wherein the computing device comprises a mobile device, and the chassis comprises an outer body of the mobile device.

### Example 20

A computing device as described in one or more of examples 15-19, further comprising an inductor connected between the antenna and the chassis to customize an inductance of the integrated antenna structure.

### CONCLUSION

Techniques for implementing an integrated antenna structure are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A wireless device comprising:
a chassis;
one or more electronic circuits positioned within the chassis;
a ground plane positioned within the chassis; and
an antenna electrically attached to the one or more electronic circuits, the ground plane, and the chassis to form an integrated antenna structure configured to transmit and receive wireless signals for the wireless device.

2. A wireless device as recited in claim 1, wherein the antenna and the chassis combine to form an integrated radiating structure configured to transmit and receive the wireless signals by performing one or more of transmitting radio waves or receiving radio waves.

3. A wireless device as recited in claim 1, wherein the antenna is electrically attached to the chassis, the one or more electronic circuits, and the ground plane via separate respective connections.

4. A wireless device as recited in claim 1, further comprising an inductor connected between the antenna and the ground plane to customize an inductance of the integrated antenna structure.

5. A wireless device as recited in claim 1, further comprising an inductor connected between the antenna and the chassis to customize an inductance of the integrated antenna structure.

6. A wireless device as recited in claim 1, further comprising a capacitor connected between the antenna and the ground plane to customize a capacitance of the integrated antenna structure.

7. A wireless device as recited in claim 1, wherein the electronic circuits comprise a wireless module configured to interact with the antenna to enable wireless signal to be transmitted and received by the client device.

8. An integrated antenna structure comprising:
a chassis; and
an antenna electrically attached to the device chassis such that the antenna and the chassis combine to form an integrated radiating structure configured to transmit and receive wireless signals for a wireless device.

9. An integrated antenna structure as recited in claim 8, further comprising a ground plane separate from the chassis and to which the antenna is electrically attached separately from the chassis.

10. An integrated antenna structure as recited in claim 8, further comprising one or more electronic circuits to which the antenna is electrically attached separately from the chassis.

11. An integrated antenna structure as recited in claim 8, further comprising:
a ground plane separate from the chassis and to which the antenna is electrically attached separately from the chassis; and
one or more electronic circuits to which the antenna is electrically attached separately from the chassis and the ground plane.

12. An integrated antenna structure as recited in claim 8, further comprising a ground plane separate from the chassis and to which the antenna is electrically attached separately from the chassis, and an inductor connected between the antenna and the ground plane to customize an inductance of the integrated antenna structure.

13. An integrated antenna structure as recited in claim 8, further comprising an inductor connected between the antenna and the chassis to customize an inductance of the integrated antenna structure.

14. An integrated antenna structure as recited in claim 8, further comprising an electrically conductive foam positioned between the antenna and the chassis that enables electrical attachment of the antenna to the chassis.

15. A computing device comprising:
a chassis;
a display surface mounted on an outer portion of the chassis; and
an antenna positioned within the chassis at least partially beneath the display surface and electrically attached to the chassis such that the antenna and the chassis combine to form an integrated radiating structure configured to transmit and receive wireless signals for the computing device.

16. A computing device as recited in claim 15, further comprising a ground plane positioned within the chassis at least partially beneath the display surface and to which the antenna is electrically attached separately from the chassis.

17. A computing device as recited in claim 15, further comprising one or more electronic circuits positioned within the chassis at least partially beneath the display surface and to which the antenna is electrically attached separately from the chassis.

18. A computing device as recited in claim 15, further comprising:
a ground plane positioned within the chassis at least partially beneath the display surface; and
one or more electronic circuits positioned within the chassis at least partially beneath the display surface, the antenna connected to the chassis, the ground plane, and the one or more electronic circuits via different respective electrical connections.

19. A computing device as recited in claim 15, wherein the computing device comprises a mobile device, and the chassis comprises an outer body of the mobile device.

20. A computing device as recited in claim 15, further comprising an inductor connected between the antenna and the chassis to customize an inductance of the integrated antenna structure.
